(19) United States
(12) Patent Application Publication
(10) Pub. No.: US 2019/0281812 A1
(43) Pub. Date: Sep. 19, 2019

(54) LADDER STAND AND RELATED METHOD OF USE

(71) Applicant: MAINSTREAM HOLDINGS, INC., WINDOM, MN (US)

(72) Inventors: Scott D. Lee, Bridgeport, MI (US); Robert M. Butcher, Saint Charles, MI (US)

(21) Appl. No.: 15/922,993

(22) Filed: Mar. 16, 2018

(51) Int. Cl. A01M 31/02

(52) U.S. Cl. CPC A01M 31/02

(57) ABSTRACT

A ladder stand includes a ladder, a platform, an optional seat, a tree engagement bracket, straps and strap diverter guides. The straps can be crisscrossed around the rear of the tree and extend forwardly to respective strap diverter guides. These guides can redirect the straps from a generally acute angle relative to the ladder to an orientation substantially parallel to the ladder, with the lower portions of the straps extending downwardly along the ladder. One or more tensioners can provide tension in the straps, thereby pulling the bracket into the tree under significant force to provide safe and stable securement of the ladder stand to the tree. The strap tensioning can be accomplished by a user on the ground, without ever having to climb the ladder or secure any additional straps to the tree. A related method of use is provided.

### BACKGROUND OF THE INVENTION

The present invention relates to elevated platforms, and more particularly to a cross grip securement system for a ladder stand.

There are a variety of elevated platforms that are used to elevate a wildlife observer and/or a hunter to a vantage point above the ground. These platforms are frequently attached to trees, and generally are referred to as tree stands. Tree stands come in a variety of configurations. A popular and rather stable tree stand is the ladder stand. This stand includes a ladder having multiple steps. Attached at the top of the ladder is a platform and a seat. The user can install the seat against a tree, climb the ladder and sit atop the platform and in the seat.

While ladder stands are popular, they suffer several shortcomings. For example, ladder stands are relatively heavy and bulky. Accordingly, they are difficult to transport to a tree stand site and difficult to set up. To set up a ladder stand, a user, typically aided by another helper, will lift the platform and seat upward, tilting the ladder toward the tree trunk while the base of the ladder stays in place. This lifting the ladder stand continues until the upper part of the stand engages the tree trunk at the elevated location.

With a tree stand so positioned, it must be secured so that it will not fall away from the tree trunk. This, however, presents its own issues. Some users, against manufacturer's explicit warnings, will simply climb the ladder stand to the top of the ladder and stand on the platform without prior securement of the stand. While in this position, the user will secure a primary strap horizontally around the trunk and to the back of the seat and/or the platform. Thus, against the warning of the manufacturer, the user climbs the ladder stand while it is unsecured, in which case it could lose contact with a tree and fall.

Some ladder stands are offered with the above noted primary strap, located at the platform and/or seat, as well as secondary straps that are wrapped around the tree well below the platform and seat, more than half way down the height of the ladder or more, and then back toward the bottom of the ladder almost at ground level. These secondary straps extend directly from contact with the tree to the location where they are directly tied to the bottom of the ladder, usually at a lower rung on the ladder. Thus, such secondary straps are tightened to the degree that a user can manually pull on the straps and simultaneously tie them to the ladder. These straps also contact the low on the tree, and over a rather large vertical area on the trunk, which contributes to very low holding forces of these secondary straps. A combination of these factors results in an insignificant force, sometimes less than about 25 pounds, exerted on the tree by those secondary straps, to supplement the force exerted by the primary strap. Accordingly, such secondary straps offer little additional securement to the tree.

Some manufacturers provide an aftermarket ladder stand securement claw which can clamp a portion of a ladder to the tree trunk at an elevated location, thereby providing some level of securement of the ladder to the tree trunk. This securement claw, however, adds weight to the upper extremities of the ladder, and makes the ladder heavier and bulkier, and more difficult to install against the tree. Further, the securement claw typically is removed after the ladder stand is in place. Thus, this device must be carried away from the stand site as well, adding one more item to keep track of and transport by the user.

Accordingly, there remains room for improvement in the field of elevated platforms, and in particular, the securement of ladder stands to trees for hunting or observation activities.

### SUMMARY OF THE INVENTION

A ladder stand including a ladder, an optional platform, an optional seat, a tree engagement bracket, one or more straps and strap diverter guides is provided.

In one embodiment, the strap diverter guides are placed high on the ladder so that straps, placed around the rear of the tree and over the strap diverter guides, can be placed under sufficient tension to operate as a force multiplier so that the parts of the straps around the tree exert a force significant enough to secure the stand to the tree without the user having to climb the ladder and while the user manipulates the straps on the ground.

In another embodiment, the diverter guides are placed high on the ladder, in the upper part of the length of the ladder, optionally in the upper ½ or ⅓ of the ladder height, so that the straps crisscross one another on the rear of the tree at acute opposite angles so as to distribute a significantly increased force over a small predetermined area and to thereby enhance securement of the ladder stand to the tree via the straps.

In yet another embodiment, the straps can be crisscrossed around a rear surface of a tree and can extend forwardly to respective strap diverter guides. From the diverter guides, the straps can extend downward, optionally substantially parallel to the ladder. A tensioner can provide tension in the straps to exert a significant force on the tree. This in turn, pulls the tree engagement bracket into the tree with a complimentary force to provide safe and stable securement of the ladder stand to the tree. The strap tensioning can be accomplished by a user on the ground, without the user ever having to climb the ladder or secure any additional straps to the tree until after the ladder stand is secured in place with the straps.

In another embodiment, the strap diverter guides can be constructed to include an opening and/or a recess that captures one or more straps. For example, a strap diverter guide can include an upwardly projecting arm or prong that extends along an outer rail of the ladder. The arm or prong can be configured in a U- or V-shape, or generally opening upward in a concave or bowed manner. The opening can be sized to capture the strap when the strap is dropped or flung into it.

In still another embodiment, the ladder can include a length. The length can be divided into thirds. The strap diverter guide can be located in the upper third of the length so that the straps can be tensioned in that upper third of the length to strongly secure the tree engagement bracket against the tree without potentially bending the ladder.

In even another embodiment, the straps can be oriented relative to the ladder in different orientations. For example, a strap can include an upper portion that wraps partially around the tree, traverses a longitudinal axis of the ladder, and then extends back toward a strap diverter guide. Between the tree and the ladder, the strap can be disposed at an acute angle relative to the ladder. The strap can extend over the diverter guide and transition to a lower portion of the strap. The lower portion of the strap can be substantially parallel to the ladder extending downward from the strap diverter guide.

In a further embodiment, the lower portion of the strap can be at a generally obtuse and/or right angle relative to the upper portion of the strap between the tree and the ladder. The particular angle can be selected depending on the force desired to be applied to the tree to pull the tree engagement bracket and the ladder stand against the tree for stability and securement.

In yet another embodiment, the straps can be constructed from single or multiple components. For example, the entire strap can be constructed from a single material, or an upper portion of a strap can be constructed from one material and the lower portion can be constructed from another material. As a further example, the upper portion can be constructed from a metal and/or composite material, such as a twisted steel cable constructed from metal strands. This cable can directly engage the tree, for example the rear surface of the tree to provide bite and grip on that surface. The cable can transition to and can be joined with a web, cord, rope, chain or other elongate member that extends to the lower portion and optionally extends over the diverter guide. This web can ride and/or slide over the strap diverter guide without wearing out the web or the diverter guide by creating extra friction or abrasion against that guide.

In a further embodiment, the tensioner can be in the form of a ratchet joined with or included in a strap. The ratchet can include a spool rotatably joined with a base and a lever that selectively engages the spool to rotate the spool about an axis of rotation. When the spool is rotated, and associated portion of the strap, for example a web, can be wound onto the spool to produce a tension within the strap that is translated to the force exerted by the strap on the tree to secure the ladder stand to the tree. Optionally, the ratchet can be attached to a hook or another portion of a strap that includes a hook. That hook can be joined with a portion of the ladder stand below the strap diverter guide, generally closer to ground level.

In still a further embodiment, a method of installing a stand relative to a structure such as a tree is provided. The method can include engaging the tree engagement bracket against the tree above ground level and extending one or more straps from adjacent the tree engagement bracket around the tree and toward respective strap diverter guides. The straps can be installed over the diverter guides such that an upper portion of a strap is disposed at an angle relative to the ladder above the diverter guide. A lower portion of the strap can be disposed substantially parallel to the ladder below the respective strap diverter guide. A tension can be exerted in the first and/or second strap by a user, optionally by actuating the tensioner. The user can exert this tension before the user traverses up the ladder, but after the ladder has been placed against the tree for a first time upon installation. By exerting the tension within the strap, the upper portions of the strap exert a force against the tree, which in turn pulls the engagement bracket into the tree with a corresponding force. In some instances, where first and second straps are utilized, they can cooperatively exert a force against the rear surface of the tree, of optionally at least 50 pounds (which term is used interchangeably with pounds-force herein), further optionally at least 75 pounds, yet further optionally at least 100 pounds, even further optionally at least 150 pounds, further optionally at least 200 pounds, yet further optionally at least 250 pounds, still further optionally at least 300 pounds, further optionally at least 350 pounds, yet further optionally at least 400 pounds, still further optionally at least 450 pounds, even further optionally at least 500 pounds or in some cases more. As a result, the tree engagement bracket is pulled into forced engagement under a corresponding and substantially equal force to the values above with the tree to thereby secure the ladder in position against the tree, ready for use by the user. Thus, the user does not have to climb the ladder to secure any additional strap or structure or attachment around the tree before the force to secure the ladder is presented and generated.

In still yet a further embodiment, the method can include extending straps forward and in front of the ladder a preselected distance, for example, at least two feet or more. The straps can be manually raised above the respective strap guide and lowered into a bowed recess or hook portion of the diverter guide.

In even a further embodiment, the method can include moving a lower portion of a strap rearward, toward the ladder so that the lower portion extends between the strap diverter guide and a lower end of the ladder. Optionally, with this movement, the strap can attain an angled configuration such that the upper portion of the strap is angled at an obtuse angle relative to the lower portion of the strap under the strap diverter guide. The lower portion of the strap under the diverter guide can extend substantially parallel to the ladder.

In yet a further embodiment, the method can include applying tension to one or more of the straps with a tensioner. This can produce different force vectors that extend in different directions within different portions of the straps relative to one another. The tension can be exerted via a user manipulating the tensioner while the user is standing at ground level, before the user ever traverses up the ladder to the platform.

In still yet a further embodiment, the method can include actuating a tensioner, such as a ratchet joined with a lower portion of the strap under the strap diverter, to exert tension in the strap, again while the user is standing at ground level. The ratchet can include lever and a spool. The lever can be moved by the user to rotate the spool, thereby winding the strap onto the spool and producing the tension in the strap, which is connected at the other end to the upper portion of the ladder stand. In turn, this tension force in the strap pulls the engagement bracket against the tree under a corresponding force.

In yet a further embodiment, the straps can be placed under tension and thus the straps can pull the engagement bracket into and toward the tree with a corresponding force. The tension in one strap plus the tension one or more other optional straps (referred to as the strap force herein) can be compared to the force with which those straps pull the engagement bracket into and/or toward the tree (referred to as the bracket force). For example, the bracket force can be greater than or equal to the strap force. In some cases, the bracket force can be compared to the strap force via a ratio, bracket force: strap force, where both forces are measured in pounds, also used interchangeably herein with the units of pounds force. That ratio can be optionally at least 0.75:1; further optionally at least 0.9:1, yet further optionally at least 1:1, further optionally at least 1.2:1, yet further optionally at least 1.3:1, even further optionally 1.4:1, still further optionally at least 1.5:1, even further optionally at least 1.75:1, and still further optionally at least 2:1.

The current embodiments of the ladder stand related method of use provide benefits in elevated platforms that previously have been unachievable. For example, previously, to install a ladder stand, a user had to climb the ladder and install a single strap above the platform of the ladder around the tree to firmly secure the ladder in place against a tree. Thus, the user had to work with extreme caution while securing the stand in a stable configuration at an elevation above the ground level. With the present ladder stand, a user can apply a significant force against the tree to securely lock and engage the tree engagement bracket in place and against the tree, all while operating at ground level. Thus, while on the ground a user can fully install the ladder stand so that it is sturdy, stable and unlikely to tip or shift.

These and other objects, advantages, and features of the invention will be more fully understood and appreciated by reference to the description of the current embodiment and the drawings.

Before the embodiments of the invention are explained in detail, it is to be understood that the invention is not limited to the details of operation or to the details of construction and the arrangement of the components set forth in the following description or illustrated in the drawings. The invention may be implemented in various other embodiments and of being practiced or being carried out in alternative ways not expressly disclosed herein. Also, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof. Further, enumeration may be used in the description of various embodiments. Unless otherwise expressly stated, the use of enumeration should not be construed as limiting the invention to any specific order or number of components. Nor should the use of enumeration be construed as excluding from the scope of the invention any additional steps or components that might be combined with or into the enumerated steps or components.

### BRIEF DESCRIPTION OF THE DRAWINGS

FIG. 1 is a side view of the ladder stand of a current embodiment fully installed on a tree;

FIG. 2 is a rear perspective view of the ladder stand fully installed on the tree;

FIG. 3 is a front perspective view of the ladder stand fully installed on the tree;

FIG. 4 is a side view of the ladder stand as a user installs a strap relative to a strap diverter guide;

FIG. 5 is a close-up view of a tensioner for use with the ladder stand;

FIG. 6 is a side view of the ladder stand as a user further installs a strap to secure the ladder stand and stabilize it relative to a tree;

FIG. 7 is a first alternative embodiment of the ladder stand with straps in different orientations;

FIG. 8 is a second alternative embodiment of the ladder stand with different configurations of diverter guides and orientations of the straps;

FIG. 9 is a third alternative embodiment of a ladder with the strap system;

FIG. 10 is a side view of a first example of a ladder stand compared to the ladder stand of the current embodiment;

FIG. 11 is a side view of a second example of a ladder stand compared to the ladder stand of the current embodiment; and

FIG. 12 is a top view of a force testing set up utilized in comparing ladder stands.

### DESCRIPTION OF THE CURRENT EMBODIMENTS

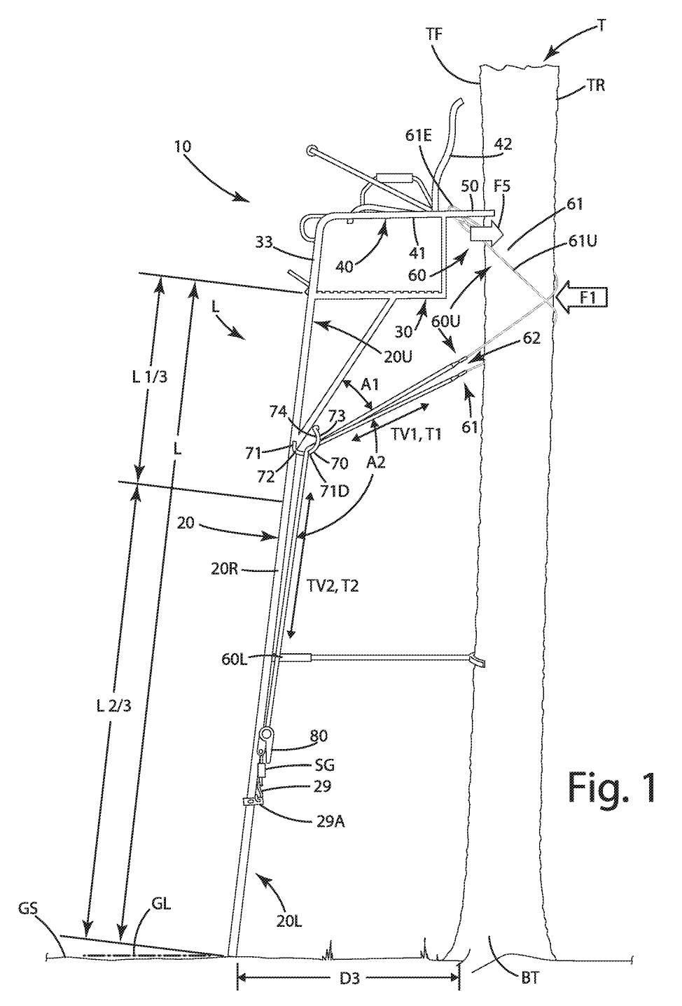

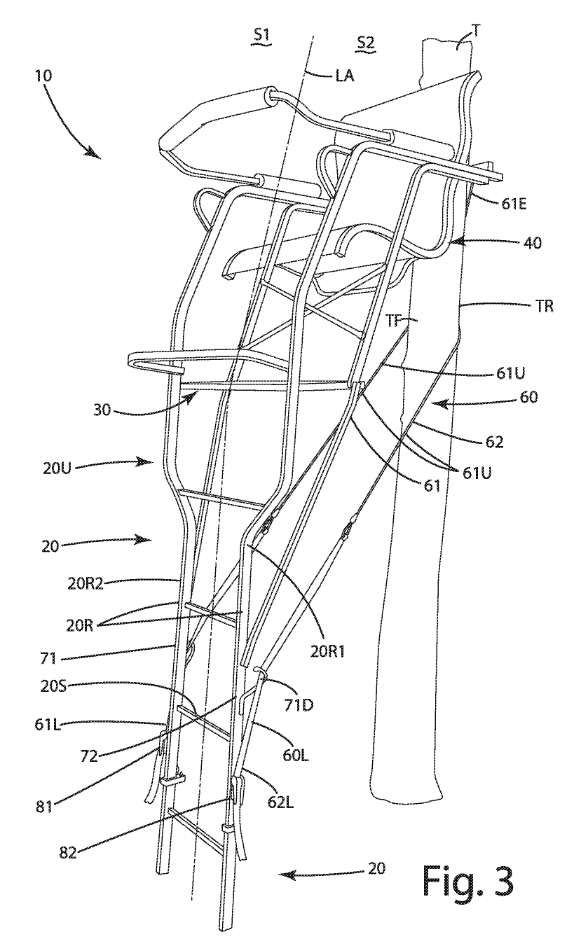

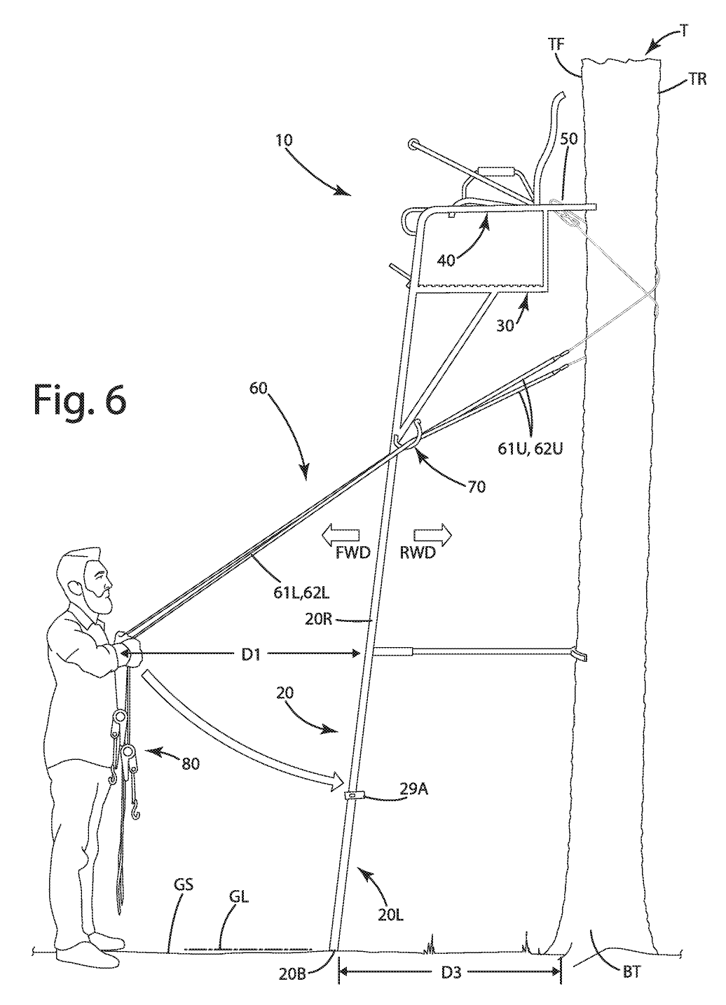

A current embodiment of the ladder stand and its method of use is illustrated in FIGS. 1-6, and generally designated 10. The ladder stand 10 can include a ladder 20 joined with a platform 30 which can be further joined with an optional seat 40. The seat, the platform and/or the ladder can be joined with a tree engagement bracket 50. The ladder stand can be secured to the tree via the straps 60 which can wrap around the rear surface TR of the tree T and extend back forwardly in front of the front surface TF of the tree T to the strap diverter guides 70. The diverter guides 70 can redirect the strap 60 so that a strap lower portion 60L extends downwardly, optionally substantially parallel to the ladder 20 to a lower end 20L of the ladder 20. The strap lower portion 60L can be attached to the ladder and an attachment element 29 via a portion of the strap itself and/or a tensioner 80 that is joined with the straps 60. The tensioner 80 can be tightened to exert a tension T1, T2 in the straps along their lengths, in different portions. In turn, this can exert a force F1 by the straps where they engage the tree, optionally along the tree rear surface TR. This force F1 can pull the tree engagement bracket 50 forcibly into the tree to secure the upper portion of the ladder, the platform and the seat in place, securely and in a stable manner. The straps as described below can be installed around the tree and relative to the strap diverter guides, and also tightened while a user U stands on the ground surface GS, at ground level GL. Thus, the user need not climb the ladder 20 to secure the ladder stand 10 to the tree T at any point during installation of the ladder stand.

The current embodiment is described in connection with a ladder stand, which generally includes a ladder, platform, and a seat. The current embodiment, however, can be utilized with other types of observation and/or hunting platforms that are elevated, regardless of whether they include a seat or a platform. The current embodiment also can be utilized in connection with one or more ladder sections that are secured to a tree, with a portable platform attached adjacent and/or above the top of the ladder. As used herein, the term tree can refer to a live, relatively tall natural plant, as well as a dead plant, a telephone pole, some other type of pole or upright beam, or any other type of similar, tall support structure that has a generally fixed and stationary base and extends upwardly into the air from the ground level. Further, as used herein, the term strap can include a web, a cord, a wire, a rope, as well as a chain, a cable, a wire, combinations of the foregoing, or any other type of elongate flexible members.

Turning now to the components of the ladder stand 10, reference is made to FIG. 1. The ladder 20 can be a single contiguous structure including one or more steps 20S that are transverse to one or more rails 20R. Each rail can be elongate, generally vertical structures. The ladder can extend from a lower end 20L to an upper end 20U. The lower end can be outfitted with one or more feet or ends that can engage the ground surface at ground level. The ladder stand can be structured so that the lower end can be positioned a distance D3 from the base of the tree BT. This distance can be 2 feet, 4 feet, 6 feet, 8 feet or other dimensions depending on the application and the height of the ladder stand. The ladder 20 can be of a length L. This length L can be subdivided into thirds, for example, an upper third L⅓ and a lower two thirds L⅔. The lower two thirds portion of the length L can be that portion closest to the lower end 20L. Optionally, the ladder 20 can be constructed from multiple individual sections that are secured one to the next to form the entire length L of the ladder. Further optionally, although not shown, the ladder 20 can include only a single rail or single pole that is joined with the platform. The single rail can include rungs that project laterally outward from the rail to function as steps for a user. This single rail ladder can function with the securement system similar to the two rail ladder described herein.

The ladder 20 and the one or more ladder rails 20R can extend upward to a platform 30 and a frame 33. The platform can be a flat platform constructed from metal mesh, a polymeric sheet, a wooden sheet, a cast aluminum frame or some other structure capable of being stood upon by a user when occupying the tree stand 10. The platform and/or the frame can be joined with an optional seat 40 that includes a seat bottom 41 and an optional seatback 42. In some cases, the seat 40 can be eliminated from the construction, so that the user stands only on the platform 30. In other cases, the platform 30 can be eliminated and the seat 40 can be joined with the ladder so that a user sits upon the seat and places their feet on one of the rungs 20S.

The ladder stand 10 can include a tree engagement bracket 50. This tree engagement bracket can be attached to or otherwise form a portion of the frame 33, the seat 40, the platform 30 and/or the ladder 20. The tree engagement bracket 50 can include a V- or U-shaped member 50V configured to directly engage the tree T. This member 50V can include one or more teeth that are adapted to bite into and engage the bark or other surface of the tree, providing an extra grip of the bracket to the tree. Although shown as including only a single bracket 50, the ladder stand 10 can include one or more additional brackets of similar shape and construction disposed above and/or below the bracket 50. In some cases, the platform 30 can be integrally joined with another tree engagement bracket to complement the bracket shown.

The ladder stand can include the straps 60 which are described in further detail below. The straps can extend over the strap diverter guides 70. The strap diverter guides 70 can include a first diverter guide 71 and a second diverter guide 72. The strap diverter 70 can be attached and joined with the ladder 20, in particular the side rails 20R1 and 20R2 that are disposed on a first side S1 and a second side S2 of the longitudinal axis LA, which extends along the ladder 20 dividing it into left and right portions. The strap diverter guides 71, 72 can be identical but mirror images of one another, so only one will be described here. As shown in FIG. 1, a strap diverter guide can include an arm or prong 73 that extends outwardly and laterally away from the longitudinal axis LA, away from the side rail 20R1. The arm 73 can extend at first downwardly along a portion of the rail, and then upwardly as illustrated. The arm can be configured to form an opening or bowed recess or hook portion 74 and a top portion thereof. The opening or recess can be generally U- or V-shaped. The arm 73 and a portion of the rail 20R1 can cooperatively extend upwardly to the uppermost portion of that opening 74. The recess or opening 74 can be defined and dimensioned so as to capture and retain a respective strap therein. Generally the U-shape opening 74 faces upward so that the strap can be dropped by gravity, flipped or otherwise swung into that opening 74 so the arm 73 captures and retains the respective strap, in this case the first strap 61.

With reference to FIG. 1, the strap diverter guides 70 can be located in an upper third L⅓ of the length L of the ladder or the upper ⅓ generally of the overall height of the ladder stand. Of course, in other cases, the strap diverter guide 70 can be located in the upper quarter, upper half, upper two thirds of the length L of the ladder, depending on the application, the height of the ladder and/or the configuration of the tree T. The strap diverter guides 70 can be fastened to the associated rails 20R with fasteners, such as bolts, screws, rivets or other constructions. Where there optionally is only one rail of the ladder, the diverter guides can be on opposite sides of that rail. Although shown as being fastened with fasteners, the strap diverter guides optionally can be welded directly to the rails or other portion of the ladder stand.

Optionally, the one or more rails 20R1 and 20R2 can include and define multiple fastener holes along the length thereof. Thus, the strap diverter guides can be moved upward or downward, adjustably along and then attached to the rails to provide different forces and or otherwise reorient the straps and their connections to the tree.

With reference to FIGS. 1-3, the straps 60 can include a first strap 61 and a second strap 62. The straps 61 and 62 can be generally identical, but placed in different locations, and can extend along different routes to and from sides S1 and S2. Due to the similarities, only one of the straps 61 will be described here with regard to its optional structure. The strap 61 can include an upper portion 61U. The upper portion 61 can include an upper end 61E that is joined with the upper portion of the ladder stand 10 optionally adjacent the tree engagement bracket 50. The end 61F can be tied, clamped, looped, staked, fastened, welded or otherwise joined to the bracket, the frame, the platform, the seat and/or the ladder, depending on the application. When stand 10 is partially or fully installed against the tree, the strap 61 can extend downward from adjacent the tree engagement bracket 51 from a location in front of the tree front surface TF, around the rear surface TR of the tree where it engages that surface. This portion of the strap 61 can be referred to as the upper portion 61U. Strap 61 continues between the tree T and the ladder 20 toward the strap diverter guides 70, and in particular the first strap diverter guide 71 located on the second lateral side S2 the longitudinal axis LA. The strap extends over the first strap diverter guide 71 and is redirected downward alongside the rail 20R2 toward the ground GS. The strap can extend to the optional tensioner 82 can be fastened to the lower end 20L of the ladder 20. The strap can include or otherwise be joined with a tensioner 80 which is described below.

Optionally, where the straps engage the rear surface of the tree, the system can include a plate or other element with teeth, spikes or other protrusions. These protrusions can assist in making the straps bite into the tree surface, thereby enhancing the securement of the straps to the tree, and to provide a surface where the forces of the straps can be focused.

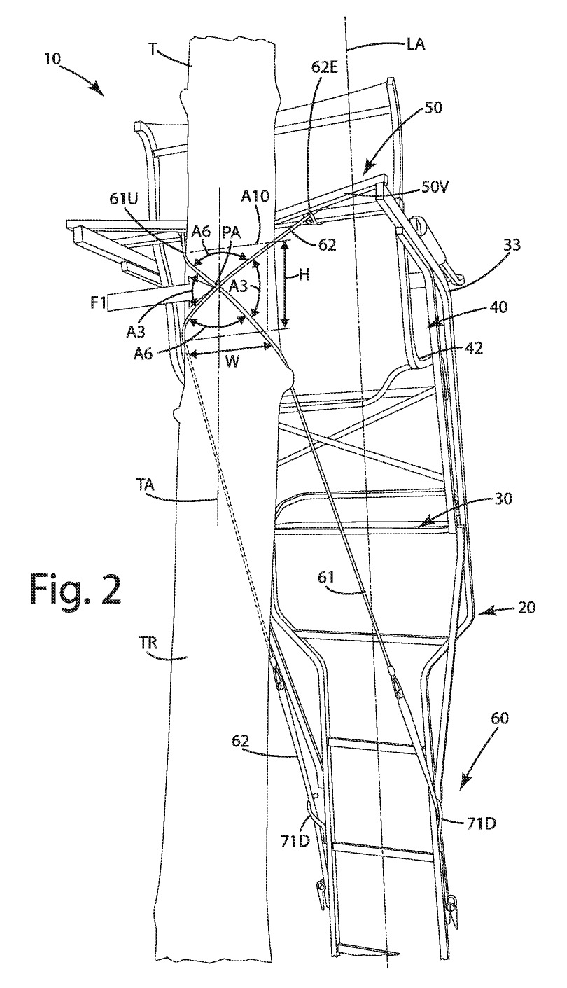

Further optionally, the straps 61 and 62 can be configured so that the strap upper portions 61U and 62U are disposed and crisscrossed relative to one another on the rear surface TR of the tree as shown in FIG. 2. There, the upper portions of the straps form two pairs of opposite angles, that is, angles A3 and A6. Angles A6 can be equal and angles A3 can also be equal, and disposed across from another on opposite sides of the tree axis TA, which generally extend substantially vertically in some cases where the tree is vertical. Angles A3 can optionally be acute angles, further optionally less than 90°, yet further optionally less 50°, yet further optionally less than 45°, still further optionally less than 40°, yet further optionally less than 35°, still further optionally less than 30°, even further optionally between 25° and 45°, still further optionally between 35° and 55° and yet further optionally non-obtuse angles. Of course other angles can be selected here, but the inventor has observed that where the angles A3 form acute angles, the force F1 can be applied in a small predetermined area A10, which can provide significant pressure against the rear surface of the tree to provide improved securement of the stand to the tree. It is also to be noted that the acute angles mentioned above can be achieved due to the fact that the diverter guides are located optionally in the upper half, optionally upper third, and further optionally upper quarter of the length L of the ladder. In turn, the forces translated by the tensioners to this area A10 is multiplied by 2, 3, 4, 5, 10, 20 or more times to provide significant holding strength. Optionally, the predetermined area can have a width W transverse to the tree axis TA and a height H parallel to the tree axis. The height and width can delimit the dimensions where the straps engage the tree. The width can be greater than the height, which in some cases can increase the pressure distribution in that area to enhance securement of the ladder stand to the tree.

As shown in FIGS. 1-3, strap 61 can include an upper portion 61U and a lower portion 61L. Generally, both straps 61 and 62 can include such upper 60U and lower 60L portions. The upper portion 61U and generally 60U can extend between the tree and the ladder 20. There it can be disposed at an angle A1 relative to the ladder 20. This angle A1 can be an acute angle, optionally between 30° and 80°, further optionally between 40° and 60°, yet further optionally about 45°. The diverter guide 70, for example, guide 71 can redirect the strap 61 and produce in the first strap, and the straps in general, a diversion portion 71D. This diversion portion 71D is angled such that the upper portion 60U and lower portion 60L of the straps are redirected and angled relative to one another, with the apex of the angle generally being at the interface of the strap and the respective diverter guide 70. Downward from the diversion portion 71D, the strap 61 transitions to the lower portion 61L, 60L of the straps in general. The upper portion of the straps 60U in general, and in the upper portion 61U of the first strap, can be disposed at a second angle A2 relative to the lower portion of the first strap 61L and in the straps 60L in general. This second angle A2 can be an obtuse angle, optionally greater than 90° but less than 180°, further optionally between 100° and 160°, further optionally about 120°. Of course, other angles can be selected here depending on the construction, the position of the diverter guide and the other components of the ladder stand relative to the tree T.

As mentioned above and shown in FIGS. 1-3, the lower portion 61L of the first strap, and generally the lower portions 60L of the straps 60 can extend substantially parallel to the rails 20R of the ladder 20. By substantially parallel, it is meant that one or more of the straps is optionally between 0° and 15° offset relative to the ladder rails 20R. The lower portions 60L of the straps can extend downward and can be attached to the lower end 20L of the ladder with an attachment element 29. This attachment element can be a hook, a loop, a fastener, or some other device that can join the strap with the ladder 20. The attachment element can optionally be joined to a bracket or arm 29A extending from the ladder in the lower part of the ladder.

Optionally, the straps 60 can be constructed from different materials along their lengths. As an example, the upper portion 61U of the first strap 61 can be constructed from a metal cable including multiple twisted metal strands. This metal cable can be joined with a polymeric, elongated web that extends downwardly, over the first diverter guide 71 into the tensioner 80. The cable and the polymeric web can be joined via a crimp, a clamp, a fastener or some other connector to hold them together along the length of the strap. The cable in the upper portion adjacent the tree can engage the tree and bite into its surface or bark, thereby providing a better hold. The polymeric web extending over the strap diverter guide 70 can provide low abrasion and minimal destruction to the diverter guide and itself over time, sliding smoothly over the surfaces of the guide. The web in the lower portion also can interface well with the tensioner 80, optionally winding easily on a spool thereof without permanently deforming the web.

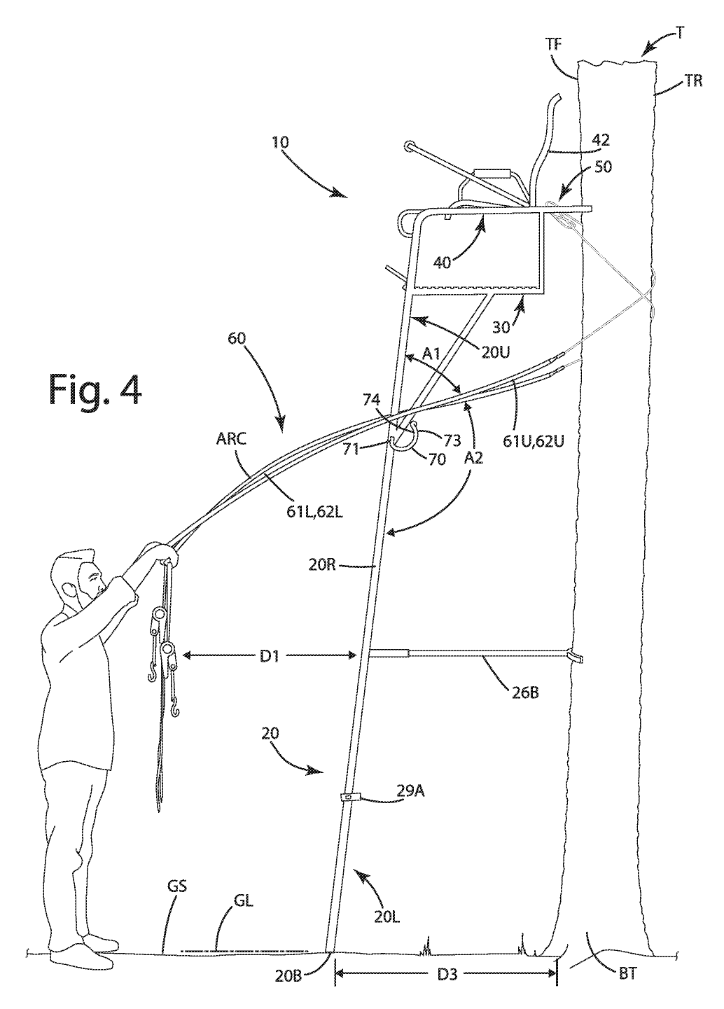

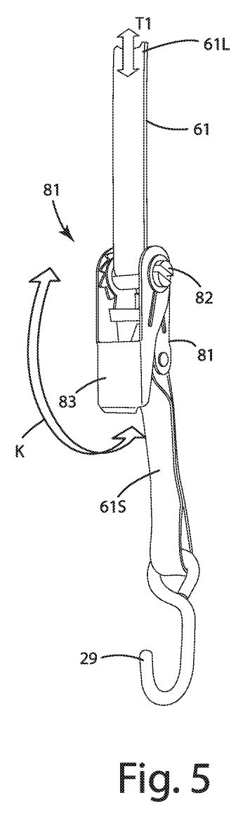

Referring to FIGS. 4-5, the straps can be joined with or otherwise include a tensioner 80. The tensioner as illustrated can be in the form of a ratchet, a come along, a turn buckle, a cam over system, a mini-winch (motorized or not), or other tension inducing mechanisms. Where the tensioner is a ratchet, the can include a base 81 to which a spool 82 is rotatably mounted. The spool 82 can be joined with a lever 83. The lever can be actuated in direction K to rotate or otherwise move the spool 82. As a result, a portion of the strap 61 can be wound onto or wound off the spool. The ratchet 80 also can be joined with another portion of the strap 61S, which is not wound on the spool, and which extends to the attachment element 29.

The ratchet or tensioner 80 can be operated by moving the lever 63 to rotate the spool so as to exert a tension T1 in the strap, for example the first strap 61. Optionally, there can be first and second tensioners 81 and 82 associated with the respective straps 61 and 62. When the tensioners are actuated, they can exert a first tension in the first strap and a second tension in the second strap respectively. These tensions can cooperatively pull on the respective first and second straps 61 and 62 to cooperatively exert a force F1 against the rear surface TR of the tree T which is engaged by the upper portions 60U of the straps 60. This force F1 produces a corresponding substantially equal force F5 to move or pull the engagement bracket into and/or toward the tree with that corresponding force F5. The force F1, as well as the force F5, that is, the bracket force, can be optionally at least 50 pounds (which term is used interchangeably with pounds-force herein), further optionally at least 75 pounds, yet further optionally at least 100 pounds, even further optionally at least 150 pounds, further optionally at least 200 pounds, yet further optionally at least 250 pounds, still further optionally at least 300 pounds, further optionally at least 350 pounds, yet further optionally at least 400 pounds, still further optionally at least 450 pounds, even further optionally at least 500 pounds or in some cases more. Again, as a result of the force F1 applied by the straps against the tree, the corresponding force F5 is exerted to pull and/or move the tree engagement bracket 50 into and/or toward forced engagement with the tree T to thereby secure the ladder in position against the tree, ready for use by the user.

Applicant has discovered that the force F1 exerted against the tree by the straps 60, and thus the corresponding force F5 by which the engagement bracket is forced toward or against the tree, utilizing the current embodiment of the ladder stand 10, can be multiplied to surprising and unexpected levels. To illustrate these surprising and unexpected results, testing and/or analysis was performed on three ladder stand systems in the following three non-limiting examples.

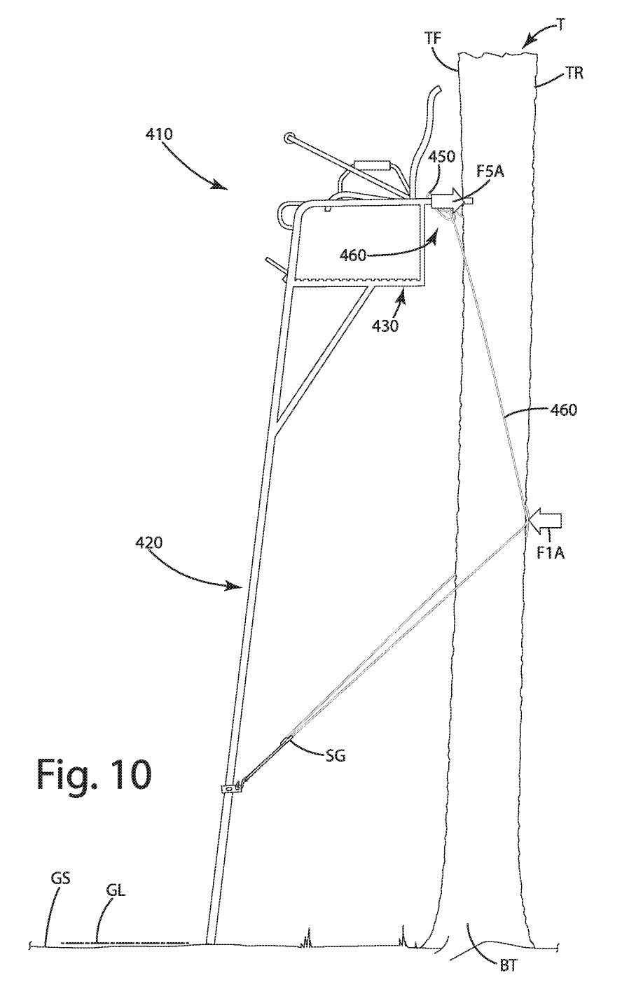

In a first example, a ladder stand 410 set up as shown in FIG. 10 was evaluated. This ladder stand 410, however, was different from the ladder stand 10 above, including no strap diverter guides as in the ladder stand 10 above. The ladder stand 410 included a platform 430, a ladder 420 and a tree engagement bracket 450 similar to the embodiment above. The straps 460 were also similar, however, because there were no diverter guides to hold them up, the straps also were placed lower on the tree as shown. Further, the straps 460 included no tensioner, so they had to be pulled manually by a user and attached to the ladder 420 via tying or fastening. In this example, a strain gauge SG was joined with the lower portion of each strap. Each strap was pulled manually and tied or otherwise attached to the ladder 420 as shown. After the straps were tightened and attached, the strain gauge SG on each strap measured the tension in each strap at about 30 pounds force (which is used interchangeably with pounds herein). The tension in one strap plus the tension in the other strap, that is, the strap force, was then determined to be about 60 pounds force. Based on that measurement and the configuration of the straps 460, the force F1A and corresponding force F5A were determined. The resulting force F5A of the engagement bracket 450 on the tree T and the tree front surface TF, that is, the force with which those straps pull the engagement bracket into and/or toward the tree, that is, the bracket force, was determined to be about 37 pounds force.

Thus, the bracket force in this first example was much less than the strap force. This bracket force was compared to the strap force via a ratio, bracket force: strap force, where both forces are measured in pounds force. (which again is used interchangeably with pounds herein) The ratio was 0.6:1. This provided very little holding force to secure the engagement bracket against the tree. Accordingly, this set up provided insufficient force to permanently hold the ladder stand against the tree.

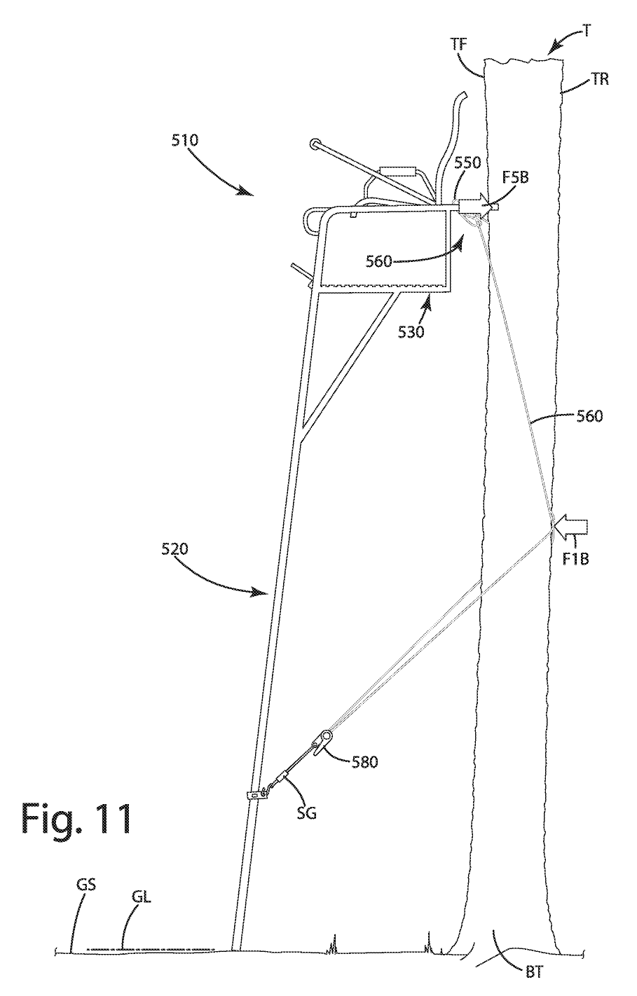

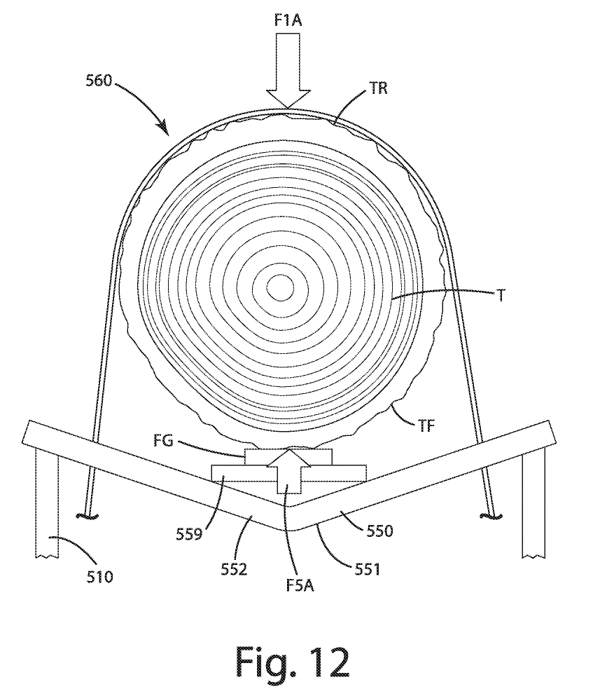

In a second example, another ladder stand 510 set up as shown in FIG. 11 was evaluated. This ladder stand 510, however, was different from the ladder stand 10 above, including no strap diverter guides as in the ladder stand 10 above. The ladder stand 510 included a platform 530, a ladder 520 and a tree engagement bracket 550 similar to the embodiment above. The straps 560 were also similar, because there were no diverter guides to hold them up, so the straps also were placed lower on the tree as shown. The straps 560, however, each included a tensioner 580 in the form of a ratchet strap shown in FIG. 5. In this example, a strain gauge SG was joined with the lower portion of each strap. Each strap was put under tension via the respective tensioner, that is, by rotating the ratchet. After the straps were tightened, the strain gauge SG on each strap measured the tension in each strap at about 46 pounds force. The tension in one strap plus the tension in the other strap, that is, the strap force, was then determined to be about 92 pounds force. The force F1B and corresponding force F5B were determined. For the force FSB, a measurement set up as shown in FIG. 12 was used. There, a planar plate 559 was placed adjacent the two bars 551 and 552 forming a V-portion of the engagement bracket 550. A force gauge FG, such as a tension or compression gauge, was placed between the plate 559 and the front surface TF of the tree T to measure the force F5B. Based on that measurement and the configuration of the straps 560, the force F5B of the engagement bracket 550 on the tree T and the tree front surface TF, that is, the force with which those straps pull the engagement bracket into and/or toward the tree, that is, the bracket force, was measured to be about 57 pounds force. This force F5B was substantially equal to the corresponding force F1B exerted by the straps against the rear TR of the tree T.

Thus, the bracket force in this second example also was less than the strap force. This bracket force was compared to the strap force via a ratio, bracket force: strap force, where both forces are measured in pounds force. The ratio also was 0.6:1. This provided very little holding force to secure the engagement bracket against the tree. Accordingly, this set up provided insufficient force to permanently hold the ladder stand against the tree. In addition, it was noted that when the straps 560 were tightened more than about 50 pounds force each, or 100 pounds strap force, the straps started to pull the engagement bracket 550 downward along the tree front surface TF. In some cases, due to their routing, the tensioners in the straps may exert too much downward vertical force on the engagement bracket 550, thus causing the bracket and the platform 530 to move down the tree, which in turn can bend the ladder 520 if too much force is exerted.

In a third example, the ladder stand 10 of FIG. 1 was evaluated. This stand included the strap diverter guides 70 and the tensioner 80 as described above. A strain gauge SG was joined with the lower portions 60L of each strap. Each strap was put under tension via the respective tensioner. After the straps were tightened, the strain gauge SG on each strap measured the tension in each strap at about 161 pounds force. The tension in one strap plus the tension in the other strap, that is, the strap force, was then determined to be about 320 pounds force. The force F1 and corresponding force F5 then were determined. For the force F5, a measurement set up similar to that shown in FIG. 12 and described above was used. Based on that measurement and the configuration of the straps 60, the force F5 of the engagement bracket 50 on the tree T and the tree front surface TF, that is, the force with which those straps pull the engagement bracket into and/or toward the tree, that is, the bracket force, was measured to be about 423 pounds force. This force F5 can be substantially equal to the corresponding force F1 exerted by the straps against the rear TR of the tree T.

Thus, the bracket force in this third example was equal to or greater than the strap force. This bracket force was compared to the strap force via a ratio, bracket force: strap force, where both forces are measured in pounds force. The ratio also was 1.3:1. This provided substantial holding force to secure the engagement bracket against the tree. Accordingly, this set up provided sufficient force to permanently hold the ladder stand against the tree. It is believed that with the diverter guides, the straps when tensioned exert the appropriate amount of horizontal force to adequately pull the engagement bracket toward and into the tree so that the ladder stand is adequately secured to the tree. Further, even with the rather large tension in the straps, due to the diverter guides, the straps did not pull the bracket down the tree.

Comparing the above examples, surprising and unexpected results with the current embodiment of the ladder stand 10 were appreciated. For example, the ladder stand 10 exhibited a bracket force or holding force of the bracket against the tree of 423 pounds force, as compared to the second example ladder stand 310 with no diverter guides of only 92 pounds force. This was an improvement of 360%. As a further example, the ladder stand 10 exhibited a bracket force or holding force of the bracket against the tree of 423 pounds force, as compared to the first example ladder stand 210 with no diverter guides of only 37 pounds force. This was an improvement of 1043%. As a result, it was appreciated that the ladder stand 10 of the current embodiment, can be utilized to entirely and fully install the ladder stand against a tree T, without the addition of a secondary strap or other substantial structure. It was also discovered, as further described below, that this ladder stand 10 and its straps can be installed entirely with the user remaining at ground level, without ever climbing the ladder off the ground.

The installation and use of the ladder stand 10 of the current embodiment will now be described in connection with FIGS. 4, 6 and 1. To begin, the ladder stand 10 is taken to a stand site and placed adjacent a tree T. The base 20B of the lower portion 20L of the ladder 20 is placed a distance D3 from the base BT of the tree, generally on the front side TF of the tree T opposite the rear side TR of the tree T. The ladder stand can be positioned so that the ladder lays on the ground surface, with the base 20B closest to the tree and the seat 40 or platform 30 distal from the tree T.

The user can attach an upper end 61E of the first strap 61 to the tree engagement bracket 50 on the first lateral side S1 of the longitudinal axis LA. The user can attach the upper end 62E of the second strap 62 to the tree engagement bracket 50 on the second lateral side S2 of longitudinal axis LA of the ladder.

The user can tilt the ladder stand 10 upward, so it rotates about the location adjacent the base on the ground. The ladder is tilted upward until the tree engagement bracket 50 engages the front surface TF of the tree. The tree engagement bracket 50 can engage the tree T optionally at least 5 feet, further optionally at least 10 feet, yet further optionally at least 12 feet, even further optionally at least 15 feet, yet further optionally at least 18 feet above the ground level GL. Optionally, a stabilizer bar 26B can be installed and secured to the tree T to provide a minor amount of support to the ladder stand 10. The user can install the stabilizer bar 26B while still standing on the ground surface GS at ground level GL.

While the ladder stand 10 is propped against the tree T, the respective first and second straps can dangle downward to the ground surface GS from the tree engagement bracket 50. While on the ground surface GS at ground level GL, the user you can grab the lower portion 61L of the first strap 61 and wrap it around the rear surface TR of the tree T so that the first strap originates on the first side S1 and traverses to the second side S2 across the longitudinal axis LA. The user can do the opposite for the second strap 62. The user can then take the first strap 61 and place it over the first strap diverter guide 71 on the second lateral side S2. To do so, the user can extend the lower portion of the straps, for example 61L and 62L beyond the ladder 20, optionally forward and in front of the ladder 20, at least optionally two feet, further optionally at least four feet, yet further optionally at least six feet.

The user can then manually raise each of the first strap and second strap upward, above the respective first and second diverter guides as shown in FIG. 4. The user can do this optionally by swinging their arms upward. The user can move their hands toward one another, above the shoulders, while the user stands the distance D1 in front of the ladder 20 and while the user holds the first and second straps in their hands. In some cases, the straps will achieve an arc shape or configuration ARC above the respective diverter guides as shown in FIG. 4. As they move inward, the straps 60 can engage the respective rails 20R, slapping against the rail or rails. After the straps engage the respective rail or rails, the user can bring their arms downward or otherwise move the straps slightly downward so that the straps move down into the U-shaped recess or opening, also referred to as a bowed recess, of the respective diverter guides 70. In some cases, after swinging the straps inward toward the longitudinal axis LA and the rails 20R, in the arc configurations, the user can simply allow the straps to fall into the bowed recess or openings defined by the respective diverter guides. Sometimes multiple attempts can be made to land the straps in the respective openings of the respective diverter guides.

With the respective straps disposed in and guided by in the respective diverter guides, the user can move the ends of the straps, for example the ends of the lower portions, also referred to as second portions, of the straps back toward the ladder. When this occurs, the lower portions 61L and 62L of the straps can be attached via the attachment elements 29 to the lower end 20L of the ladder 20. Again these attachment elements can be in the forms of hooks, and these hooks can be attached to the rungs 20S of the ladder 20. When this occurs, the lower portion 61L and 62L of the respective straps can be disposed substantially parallel to the ladder. The upper portions 60U of the respective straps 60 between the ladder and the tree can be disposed at an acute angle A1 relative to the ladder 20, which angle A1 optionally can be an acute angle. The upper 60U and lower 60L portions of the respective straps also can be disposed at an angle A2, relative to one another, which angle A2 optionally can be an obtuse angle.

Again, the straps can be installed as described above while the user U stands on the ground surface GS at ground level GL throughout the entire process before the user ever climbs the stand 10, after the stand is initially installed. With the straps 60 installed by the user, those straps can be tensioned to apply the force F1 to the tree T and thereby secure the ladder stand with that force. To do so, the user U can engage the tensioners 80, which can be associated with each of the respective straps. Optionally, both straps alternatively can be connected to a single tensioner which can operate and exert tension in both of the straps. There, where the tensioners are ratchets, the user can engage each ratchet respectively, moving the respective levers to rotate the respective spools to wind the straps onto the spools, thereby exerting tensions in the respective straps.

As a result of the tension exerted by the straps, the different portions of the strap can attain and include different force vectors pointing in different directions. For example, the upper portion of the strap 60U between the tree T in the strap diverter guide 70 can experience a first force vector TV1, while a second force vector TV2 is experienced along the lower portion 60L of the strap. The second force vector TV2 can be substantially parallel to the ladder 20. The first force vector TV1 can be disposed at an acute angle A1 relative to the ladder 20, between the strap diverter guide and the tree T. The straps can include two or more force vectors in different orientations in front of the front tree surface TF and otherwise along a portion of the ladder stand 10.

As a result of tensioning the straps, those straps cooperatively can exert a tension therein, a strap force, so that the portions of the straps that engage the tree, for example, the rear surface TR of the tree, exert the forces mentioned herein against that surface. That force F1 pulls the tree engagement bracket into the front surface TF of the tree under a force F5, that is, the bracket force, which corresponds to the force F1. In turn, this secures the ladder stand 10 in position against the tree, ready for use by the user. The user can perform the tensioning and placement of the straps and generally the positioning of the tree stand against the tree, without ever having to climb the ladder to add or secure any additional strap or other structure around the tree before the forces F1 and/or F5 are applied to the tree to secure the stand.

Analysis of the ladder stand 10 and the strap system also identified certain ratios of the tension in the straps, that is, the strap force, relative to the resulting bracket force against the tree exerted by those straps. In some cases, a suitable ratio was where the bracket force was equal to or greater than the strap force. In more particular examples, the bracket force was compared to the strap force via a ratio, bracket force: strap force, where both forces are measured in pounds force or pounds. These ratios can be optionally at least 0.75:1; further optionally at least 0.9:1, yet further optionally at least 1:1, further optionally at least 1.2:1, yet further optionally at least 1.3:1, even further optionally 1.4:1, still further optionally at least 1.5:1, even further optionally at least 1.75:1, still further optionally at least 2:1, and yet further optionally between 0.75:1 to 2:1, inclusive. Accordingly, ladder stands set up with these ratios provide sufficient force to permanently hold the ladder stand against the tree. It is believed that with the optional diverter guides, the straps when tensioned exert the appropriate amount of horizontal force to adequately pull the engagement bracket toward and into the tree so that the ladder stand is adequately secured to the tree.

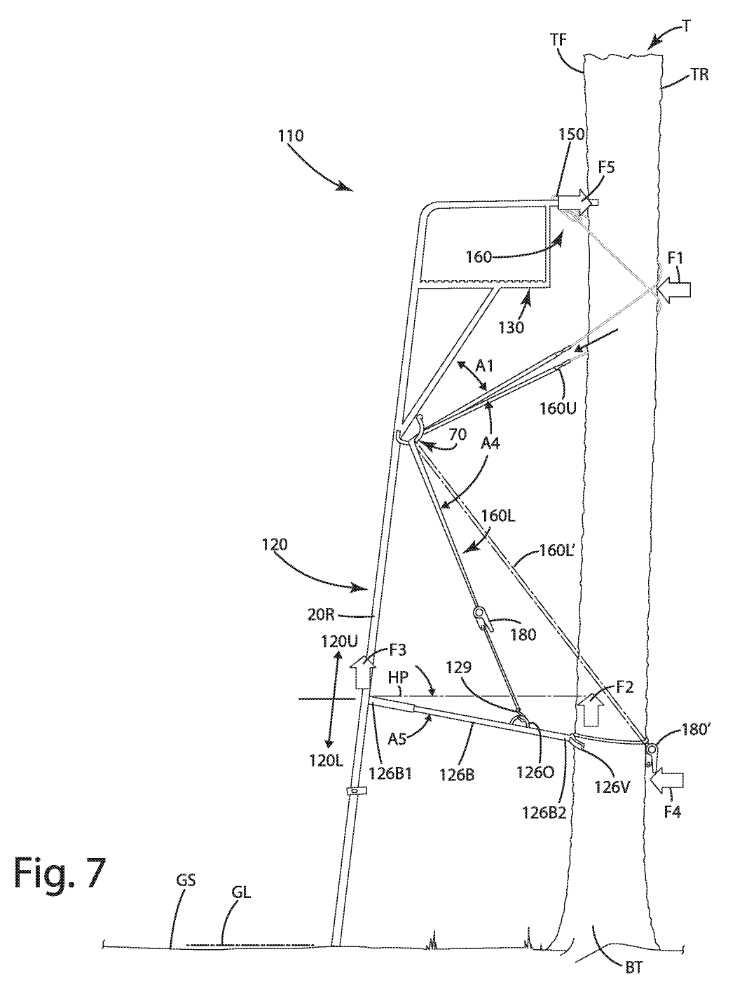

A first alternative embodiment of the ladder stand is shown in FIG. 7 and generally designated 110. This ladder stand 110 is similar to the ladder stand described in the embodiment above in structure, function and operation, with several exceptions. For example, the ladder stand 110 includes a ladder 120 to which a platform 130 is joined. No seat is present, although one could be depending on the application. The ladder stand 110 also includes a tree engagement bracket 150 that engages the tree T. The ladder stand 110 can include a stabilizing bar 126 be that extends from the ladder 120 to the tree T. Straps 160 can extend from the bracket 150, crisscross one another to exert a force F1 on the rear surface TR of the tree and then extend forward to the strap diverters 170, optionally located on opposing sides of the ladder 120 in the upper portion 120U of the ladder. The lower portions of the straps 160L however extend back toward the tree T to a connector 1260 that is joined with the stabilizer bar 126B. The straps lower portions 160L can include one or more tensioners 180 that are joined with one or more attachment elements 129 which can be of the type described above. These tensioners 180 can be tightened to exert tension in the lower portions 160L and upper portions 160U of the straps 160, similar to that explained in the embodiment above, thereby exerting a force F1 against the rear surface of the tree TR. In addition however, the straps, when under tension can exert another force F2 via the second end 126B2 of the stabilizer bar engaged against the trunk of the tree. This force F2 can be an upward force due to the tension in the straps pulling upward on the stabilizer bar 126B. Due to the tension the strap, the opposing and 126B1 of the stabilizer bar 126B can also be pulled upward thereby exerting a force F3 on the ladder 120 of the ladder stand 110. This force F3 can be substantially less than the force F2 such that the ladder 120 is not lifted off the ground surface GS.

Optionally, to impair the stabilizer bar 126B from becoming disengaged with the tree T, the stabilizer bar 126B can be disposed at an angle A5 relative to a horizontal plane HP. The angle A5 can be an acute angle, for example optionally at least 5°, 10°, 15°, 20°, 30° or more, depending on the application. Accordingly, the force F2 can have a slight horizontal component or vector to it, to project forces toward the tree T as well as upward. The precise vectors can vary depending on the orientation of the stabilizer bar relative to the horizontal plane HP.

The lower portion of the straps 160L can be joined with the stabilizer bar 126B at any portion along the length of the stabilizer bar 126B between the first end 126B1 and a second end 126B2. Optionally, the bracket 126V of the stabilizer bar 126B can include a system of teeth, spikes or other sharp protrusions that can bite into the front tree surface TF or the tree T in general, thereby preventing it from slipping up the tree and becoming disengaged from the tree when significant tension is placed in the straps 160.

In the embodiment illustrated, the straps 160 can be in a particular orientation. For example, the upper portion 160U and lower portion 160L of the straps can be disposed at an angle A4, caused by a redirection of the straps at the diverter 170. This angle A4 between the upper portion 160U and the lower portion 160L of the straps can be a right angle, and obtuse angle, or an acute angle depending on the position of the attachment element relative to the stabilizer bar 126B and the general location of the connector 1260 along that stabilizer bar between the first end 126B1 and the second end 126B2.

Also shown in FIG. 7 is a slightly different configuration for the strap lower portions 160L′. As shown in broken lines, the strap lower portions 160′ can extend around the rear surface TR of the tree and can be joined there to one another with a single tensioner 180′. The tensioner 180′ optionally can include spikes, teeth or other projections that assist in it biting into the bark or rear surface TR of the tree. In this manner, a single tensioner 180′ can be used with the bottom portions 160L′ of the straps connected to one another and wrapped again around the back or rear surface TR of the tree. The tensioner 180′ can be tightened to exert tension in the straps to exert the force F1 against the rear surface of the tree to thereby secure the engagement bracket with substantial force into the front surface of the tree TF. In this construction, the tensioner itself and/or the straps also can exert another force F4 against the rear surface of the tree below the first force F1.

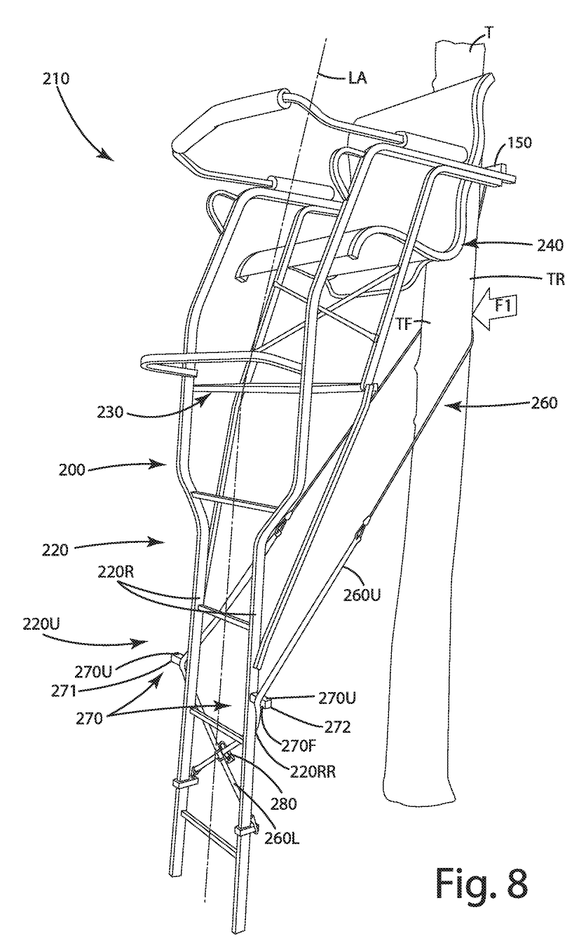

A second alternative embodiment of the ladder stand is shown in FIG. 8 and generally designated 210. This ladder stand 210 is similar to the ladder stand described in the embodiment above in structure, function and operation, with several exceptions. For example, the ladder stand 210 can include a ladder 220 to which a platform 230 and seat 240 are joined. The ladder stand 210 also includes a tree engagement bracket 250 that engages the tree T. Straps 260 can extend from the bracket 250, crisscross one another to exert a force F1 on the rear surface TR of the tree and then extend forward to the strap diverter guides 270 (271 and 272), optionally located on opposing sides of the ladder 220 in the upper portion 220U of the ladder. The diverter guides 271 and 272 can be in the form of posts, tubes, or other substantially linear projections that extend outwardly from the rails 220R of the ladder 220 generally in the upper portion 220 U. In some cases, the diverter guides can be extensions of rungs of the ladder. In other cases, they can be located between the respective ladder rungs. The lower portions of the straps 260 U can extend over the upper surfaces 270U of the diverter guides 270, over a front surface 270F of the same, and then back over a rear surface 220RR of the rails of the ladder. The lower portions 260L of the different straps can crisscross one another forming an X configuration as illustrated. The lower portions 260L can include the one or more tensioners 280 which can be manipulated manually to exert tension in the respective lower portions 260L of the straps 260. Generally, even though shown as posts extending laterally from the rails, the diverter guides also can be considered to be upwardly opening, forming an upwardly opening recess, and can enable the respective straps to be placed over the upper surfaces 270U of those diverter guides. The user can then walk the lower portions backward and around the rails and to the opposing rail from the diverter guide first engaged above the same. The tensioners 280 can be tightened to exert tension in the lower portions 260L and upper portions 260U of the straps 260, similar to that explained in the embodiment above, thereby exerting a force F1 against the rear surface of the tree TR.

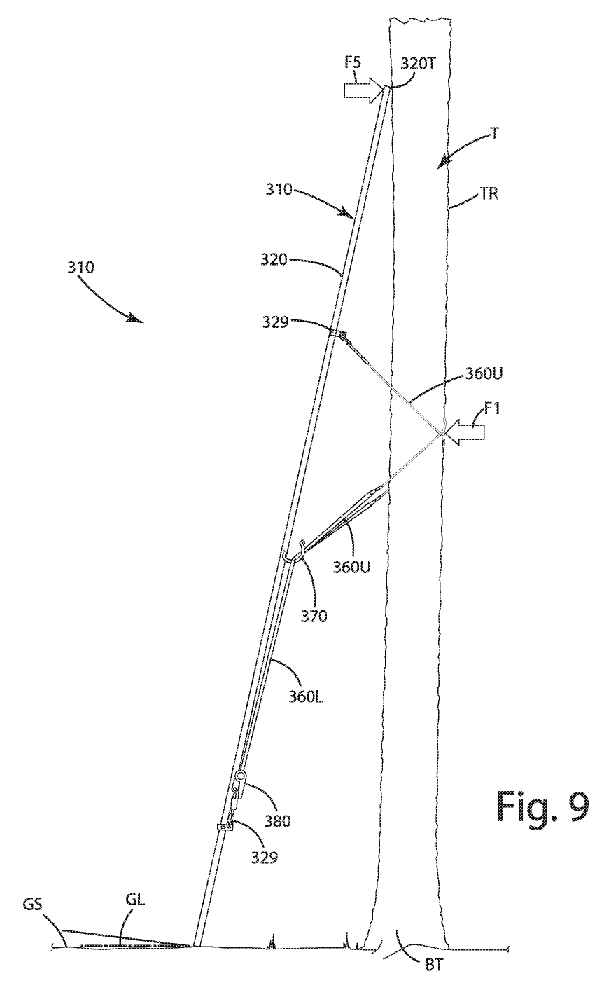

A third alternative embodiment of a ladder is shown in FIG. 9 and generally designated 310. This ladder 310 is similar to the ladder stand described in the first embodiment above in structure, function and operation, with several exceptions. For example, the ladder 310 includes a ladder 320, but no platform, seat or engagement bracket. Straps 360 extend from the attachment elements 329, which can be dedicated rings or brackets, or simply rungs to which the upper portions 360U of the straps are tied. These straps 360 crisscross one another to exert a force F1 on the rear surface TR of the tree (or a pole, where the ladder is placed against a pole) and then extend forward to the strap diverter guides 370, optionally located on opposing sides of the ladder 320. The diverter guides 370 can be similar to any of the other diverter guides mentioned herein. The lower portions of the straps 360L can extend over the diverter guides and down to the attachment elements 329. The lower portions 360L can include the one or more tensioners 380 which can be manipulated manually to exert tension in the respective lower portions 360L and upper portions 360U of the straps 360, similar to that explained in the embodiments above, thereby exerting a force F1 against the rear surface of the tree or pole to secure the ladder against that tree or pole.

Directional terms, such as “vertical,” “horizontal,” “top,” “bottom,” “upper,” “lower,” “inner,” “inwardly,” “outer” and “outwardly,” are used to assist in describing the invention based on the orientation of the embodiments shown in the illustrations. The use of directional terms should not be interpreted to limit the invention to any specific orientation(s).

The above description is that of current embodiments of the invention. Various alterations and changes can be made without departing from the spirit and broader aspects of the invention as defined in the appended claims, which are to be interpreted in accordance with the principles of patent law including the doctrine of equivalents. This disclosure is presented for illustrative purposes and should not be interpreted as an exhaustive description of all embodiments of the invention or to limit the scope of the claims to the specific elements illustrated or described in connection with these embodiments. For example, and without limitation, any individual element(s) of the described invention may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Further, the disclosed embodiments include a plurality of features that are described in concert and that might cooperatively provide a collection of benefits. The present invention is not limited to only those embodiments that include all of these features or that provide all of the stated benefits, except to the extent otherwise expressly set forth in the issued claims. Any reference to claim elements in the singular, for example, using the articles “a,” “an,” “the” or “said,” is not to be construed as limiting the element to the singular. Any reference to claim elements as “at least one of X, Y and Z” is meant to include any one of X, Y or Z individually, and any combination of X, Y and Z, for example, X, Y, Z; X, Y; X, Z; and Y, Z.

1. A method of installing a stand relative to a tree, the method comprising:
providing a ladder stand including a ladder having an upper end and a lower end, a platform joined with the upper end, and a tree engagement bracket;
engaging the tree engagement bracket against a tree above a ground surface;
extending a first strap and a second strap from adjacent the tree engagement bracket around a part of the tree and toward respective first and second strap diverter guides that are joined with the ladder, closer to the upper end than to the lower end so that each of the first strap and the second strap include an upper portion above the respective first and second strap diverter guides that is disposed at an angle relative to the ladder above the respective first and second strap diverter guides, and so that each of the first strap and the second strap include a lower portion below the upper portion and below the respective first and second strap diverter guides;
exerting a first tension in the first strap and a second tension in the second strap, before a user traverses up the ladder after the ladder has been placed against the tree, so that the upper portion of each of the first strap and the second strap cooperatively exert a force toward a rear surface of the tree,
wherein the force moves the tree engagement bracket into engagement with the tree under a bracket force thereby securing the ladder stand in position against the tree, ready for use by the user, without the user having to climb the ladder to secure any additional strap to the tree engagement bracket and around the tree before the force is applied.

2. The method of claim 1 comprising:
extending the lower portion below the respective first and second strap diverter guides such that the lower portion is substantially parallel to the ladder.

3. The method of claim 2 comprising:
moving the lower portion of each of the respective first strap and second strap forward and in front of the ladder at least 2 feet;
manually raising each of the first strap and second strap above the respective first and second strap diverter guides;
lowering each of the first strap and the second strap into an upwardly opening recess of each of the respective first and second strap diverter guides;
moving the lower portion of each of the respective first strap and second strap rearward toward the ladder so that the lower portion of each of the respective first strap and second strap extends between the respective first and second strap diverter guides and the lower end of the ladder.

4. The method of claim 1 comprising:
crisscrossing the first strap with the second strap on a rearward surface of the tree;
wherein the upper portions of each of the first strap and the second strap are disposed at an acute angle relative to the ladder above the respective first and second strap diverter guides and between the ladder and the tree.

5. The method of claim 1 comprising,
crisscrossing the first strap with the second strap on a rearward surface of the tree;
wherein the upper portions of the first strap and the second strap are disposed at opposite acute angles across a tree axis from one another so as to concentrate the force on a predetermined area on the rear surface of the tree.
wherein the diverter guide is closer to the platform than to a ground surface upon which the ladder is placed
wherein the force is at least 100 pounds.

6. The method of claim 1 comprising:
attaching an upper end of the first strap to the tree engagement bracket on a first lateral side of a longitudinal axis of the ladder;
attaching an upper end of the second strap to the tree engagement bracket on a second lateral side of the longitudinal axis of the ladder, the second lateral side being opposite the first lateral side;
attaching a lower end of the first strap to the ladder below the first strap diverter guide on the second lateral side of the longitudinal axis; and
attaching a lower end of the second strap to the ladder below the second strap diverter guide on the first lateral side of the longitudinal axis.

7. The method of claim 1,
wherein the lower portions of each of the first and second straps includes a web;
wherein the web is wound on a spool associated with a ratchet including a lever;
wherein the exerting step includes moving the lever to rotate the spool and wrap the web onto the spool to produce at least one of the first tension and the second tension in the respective first and second straps.

8. The method of claim 1,
wherein the ladder includes a length extending from the upper end to the lower end,
wherein the first and second strap diverter guides are located in an upper one third of the length, above a lower two thirds of the length,
wherein the first and second tensions produce a strap force,
wherein the ratio of the bracket force to the strap force is at least 0.75:1.

9. The method of claim 1 comprising:
before the exerting step, moving the first strap above the first strap diverter guide and subsequently down into an upwardly opening recess of the first strap diverter guide.

10. The method of claim 1 comprising:
exerting the first tension and the second tension to produce a strap force,
wherein the ratio of the bracket force to the strap force is between 0.75:1 to 2:1, inclusive.

11. A method of installing a stand relative to a tree, the method comprising:
providing a ladder stand including a ladder having an upper end and a lower end, a platform joined with the upper end and a tree engagement bracket;
positioning the lower end of the ladder adjacent a ground surface at a ground level;
leaning the ladder stand against a tree so that the tree engagement bracket engages the tree at a forward facing surface of the tree, opposite a rearward facing surface of the tree, the forward facing surface of the tree being at least five feet above the ground level;
extending a first strap from a first position adjacent the tree engagement bracket around the rearward facing surface of the tree toward the forward facing surface of the tree and toward a first strap diverter guide joined with the ladder in the upper half of a length of the ladder,
disposing a first portion of the first strap above the first strap diverter guide;
disposing a second portion of the first strap below the first strap diverter guide;
securing an end of the second portion of the first strap to the ladder;
extending a second strap from a second position adjacent the tree engagement bracket around the rearward facing surface of the tree toward the forward facing surface of the tree toward a second strap diverter guide joined with the ladder in the upper half of a length of the ladder, the second strap extending transversely over the first strap adjacent the rearward facing surface of the tree;
disposing a first portion of the second strap above the second strap diverter guide;
disposing a second portion of the second strap below the second strap diverter guide;
securing an end of the second portion of the second strap to the ladder;
exerting a first tension in the first strap and a second tension in the second strap to produce a strap force,
wherein the first strap and second strap move the tree engagement bracket so the tree engagement bracket engages with a bracket force, thereby securing the ladder stand in position against the tree, ready for use by a user, without the user having to climb the ladder to secure any additional strap around the tree before the force is applied,
wherein the ratio of the bracket force to the strap force is at least 0.75:1.

12. The method of claim 11 comprising:
guiding the first strap over the first strap diverter guide so that the first portion is at an obtuse angle relative to the second portion of the first strap;
wherein the exerting the first tension generates a first force vector along the first portion of the first strap between the tree and the first strap diverter guide,
wherein the exerting of the first tension generates a second force vector along the second portion of the first strap,
wherein the second force vector is substantially parallel to the ladder;
wherein the first course vector is disposed at an acute angle relative to the ladder between the first strap diverter guide and the tree.

13. The method of claim 11 comprising:
crisscrossing the first strap with the second strap on a rearward surface of the tree;
wherein the upper portions of the first strap and the second strap are disposed at opposite acute angles across a tree axis from one another so as to concentrate a force on a predetermined area on the rear surface of the tree.
wherein the force is at least 100 pounds,
wherein the force on the predetermined area is substantially equal to the bracket force.

14. The method of claim 11 comprising:
extending the end of the second portion of the first strap in front of the ladder by at least two feet;
swinging the first strap so that the first strap attains a first arc configuration above the first strap diverter guide;
allowing the first strap to fall into an upwardly opening recess defined by the first strap diverter guide;
moving the end of the second portion of the first strap back toward the ladder so that the first strap attains an angled configuration, with the first portion between the ladder and the tree being offset at an acute angle relative to the ladder above the first strap diverter guide.

15. The method of claim 11 comprising:
extending the end of the second portion of the first strap in front of the ladder by at least two feet;
moving the first strap above the first strap diverter guide;
moving the first strap into a recess defined by the first strap diverter guide;
moving the end of the second portion of the first strap back toward the ladder so that the second portion is substantially parallel to the ladder below the first strap diverter guide; and
pulling on the second portion of the first strap below the first strap diverter guide.

16. The method of claim 11,
wherein the ratio of the bracket force to the strap force is greater than 1:1.

17. The method of claim 11,
wherein the first strap and second strap are crisscrossed relative to one another to form two opposite, equal, acute angles disposed across a tree axis relative to one another,
wherein the bracket force is at least 100 pounds.

18. The method of claim 11,
wherein the ladder includes the length extending from the upper end to the lower end,
wherein the first strap diverter guide is located in an upper one third of the length, above a lower two thirds of the length,
wherein the first tension in the first strap is provided in the first portion of the first strap between the tree engagement bracket and the rearward facing surface of the tree, and between the rearward facing surface of the tree and the first strap diverter guide.

19. A ladder stand comprising:
a ladder having an upper end and a lower end, the lower end configured to be positioned on a ground surface at a ground level;
a platform joined with the upper end,
a seat above the platform;
a tree engagement bracket joined with at least one of the seat and the platform, the tree engagement bracket configured to engage a tree at least five feet above the ground level;
a first strap extending from adjacent the tree engagement bracket and configured to extend around the rearward facing surface of the tree, toward the forward facing surface of the tree and toward a first strap diverter guide joined with the ladder, the first strap including a first portion of the first strap disposed at an angle relative to the ladder above the first strap diverter guide, the first strap including a second portion of the first strap disposed substantially parallel to the ladder below the first strap diverter guide;
a second strap extending from adjacent the tree engagement bracket and configured to extend around the rearward facing surface of the tree, toward the forward facing surface of the tree and toward a second strap diverter guide joined with the ladder, the second strap configured to extend transversely over the first strap adjacent the rearward facing surface of the tree, the second strap including a first portion of the second strap disposed at an angle relative to the ladder above the second strap diverter guide, the second strap including a second portion of the second strap disposed substantially parallel to the ladder below the second strap diverter guide; and
a tensioner joined with at least one of the first strap and the second strap adjacent the ladder and distal from the tree, the tensioner configured to exert a tension in at least one of the first strap and the second strap to produce a strap force,
wherein the first strap and second strap are configured to pull the tree engagement surface into the tree under a bracket force thereby securing the ladder stand in position against the tree, ready for use by a user, without the user having to climb the ladder to secure any additional strap around the tree before the force is applied.

20. The ladder stand of claim 19,
wherein the ratio of the bracket force to the strap force is at least 0.75:1.
